(19) United States
(12) Patent Application Publication
(10) Pub. No.: US 2012/0326969 A1
(43) Pub. Date: Dec. 27, 2012

(54) IMAGE SLIDESHOW BASED ON GAZE OF A USER

(76) Inventors: Krishnan Ramanathan, Bangalore (IN); Nilesh Kulkarni, Bangalore (IN)

(21) Appl. No.: 13/491,136

(22) Filed: Jun. 7, 2012

(30) Foreign Application Priority Data
Jun. 24, 2011 (IN) 2130/CHE/2011

(51) Int. Cl. G06F 3/01

(52) U.S. Cl. 345/156

(57) ABSTRACT

Provided is a method to enable an image slideshow based on gaze of a user. The method displays an image to a user for viewing, wherein, invisible to the user, each image is divided into a grid of tiles. While the user is viewing the image, the method detects the gaze of the user to identify regions of the image that are of interest to the user. The identified regions of interest are mapped to the grid of tiles on the image, to recognize tiles of interest to the user. The tiles of interest for the image are calculated and another image is presented to the user for viewing when the number of tiles of interest exceeds a threshold value previously computed for the user.

### BACKGROUND

People have always been fascinated with images. A picture is a worth a thousand words is a well known cliché. Prior to the advent of a digital camera, a user had to print an image to see the result of his efforts. However, digital cameras have made life easier for both an amateur as well as a professional photographer. A user can potentially click unlimited pictures through an imaging device and instantly see the results either on the imaging device itself or by transferring them to another computing device with a display. There are many computer applications available that allow a user to view and manipulate transferred images. The user can view these images either by manually selecting each one of them individually or by using an automated feature of the application called slideshow. The slideshow mechanism allows a user to select a set of images and, after a selection has been made, displays the selected images automatically one after another. Both modes of viewing a collection of images (manual or automatic) suffer from certain limitations.

### BRIEF DESCRIPTION OF THE DRAWINGS

For a better understanding of the solution, embodiments will now be described, purely by way of example, with reference to the accompanying drawings, in which:

FIG. 1 shows a flow chart of a method for enabling an image slideshow using gaze of a user, according to an embodiment.

FIG. 2 shows an illustrative image with a grid of tiles, according to an embodiment.

FIG. 3 shows an illustrative image with a user's gaze pattern superimposed on the image, according to an embodiment.

FIG. 4 shows an illustrative table providing threshold values, computed over a set of images, for multiple users, according to an embodiment.

FIG. 5 shows a block diagram of a system for enabling an image slideshow using gaze of a user, according to an embodiment.

### DETAILED DESCRIPTION OF THE INVENTION

As mentioned earlier, a user could view a collection of digital images on a device either by using the automatic feature of a slideshow application or by manually selecting each image one after another. Both mechanisms suffer from certain limitations. In the case of automatic slide show mode (a lean-back mode), a user has no control over the transition time between display of two images. The transition time is pre-defined (or in-built) in a slideshow application and may vary across different applications. It is typically between 5 and 10 seconds. A user has to wait the transition period before the next image is displayed, even though he or she may not be interested in viewing it.

In case of manual viewing of a collection of images (a lean-forward mode), an explicit input from a user is needed before the next image is displayed. A would be required to select each image independently. Needless to say, this is not welcomed or preferred by many users.

Embodiments of the present solution provide a method and system for enabling an automatic slideshow based on gaze data of a user. A user's gaze data is analyzed across a collection of images to calculate an appropriate transition period (between two images) for a specific user. The calculated transition period is then used to present an automatic and customized slideshow for the user. Embodiments allow identification of an appropriate transition period for each individual user and enablement of an automatic slideshow (for the user) based on the identified transition period.

For the sake of clarity, the term “user”, in this document, is meant to be understood broadly. The term may include a “consumer”, an “individual”, a “person”, and the like.

Further, the term “image” may include an electronic (digital) two-dimensional image, such as a photograph, a drawing, a painting, a map, a graph, a pie chart, an abstract painting, screen display, and/or a three-dimensional image, such as a statue or hologram.

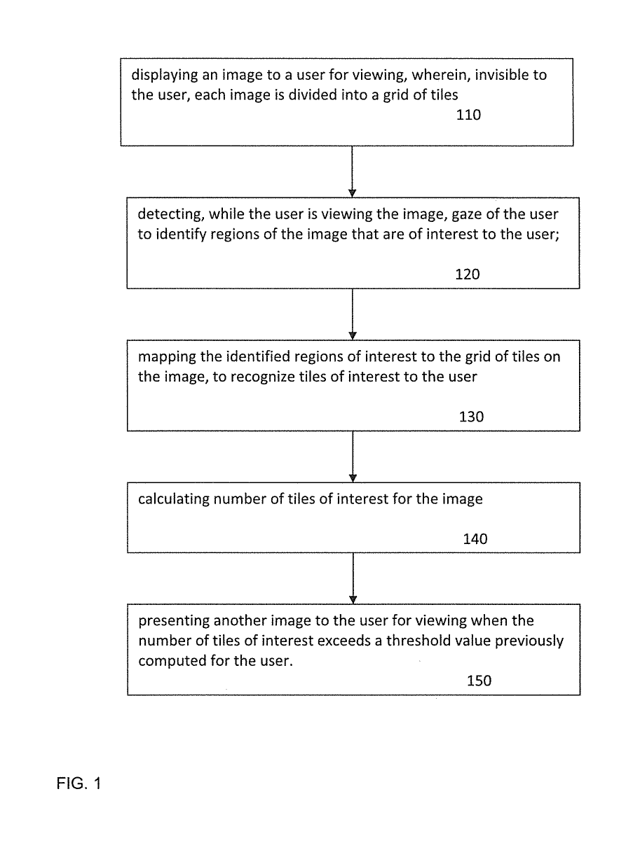

FIG. 1 shows a flow chart of a method for enabling an image slideshow using gaze of a user, according to an embodiment.

The method may be implemented on a computing device (or system), such as, but not limited to, a personal computer, a desktop computer, a laptop computer, a notebook computer, a network computer, a personal digital assistant (PDA), a mobile device, a hand-held device, a television (TV), a music system, or the like. A typical computing device that may be used is described further in detail subsequently with reference to FIG. 3.

Additionally, the computing device may be connected to another computing device or a plurality of computing devices via a network, such as, but not limited to, a Local Area Network (LAN), a Wide Area Network, the Internet, or the like.

Referring to FIG. 1, block 110 involves displaying an image to a user on a computing device. The image may be displayed on a display included with the computing device or a display communicatively coupled to the computing device. The communication between the display and the computing device may be through wired or wireless means.

The displayed image may be from a collection or set of images stored on the computing device or a storage which may be communicatively attached to the computing device. For example, the image may be stored on a hard disk of the computing device or it may be present on an external storage device, such as a USB drive, a portable hard drive, an optical disc (CD, DVD, etc.), and the like.

Also, the displayed image may be from a collection or set of images pre-selected by a user for viewing. In this case, prior to the display of an image, a user identifies the images that he or she would like to view on the computing device. The displayed image would be from the selection made by the user. In another scenario, however, the computing device may select a random image for display.

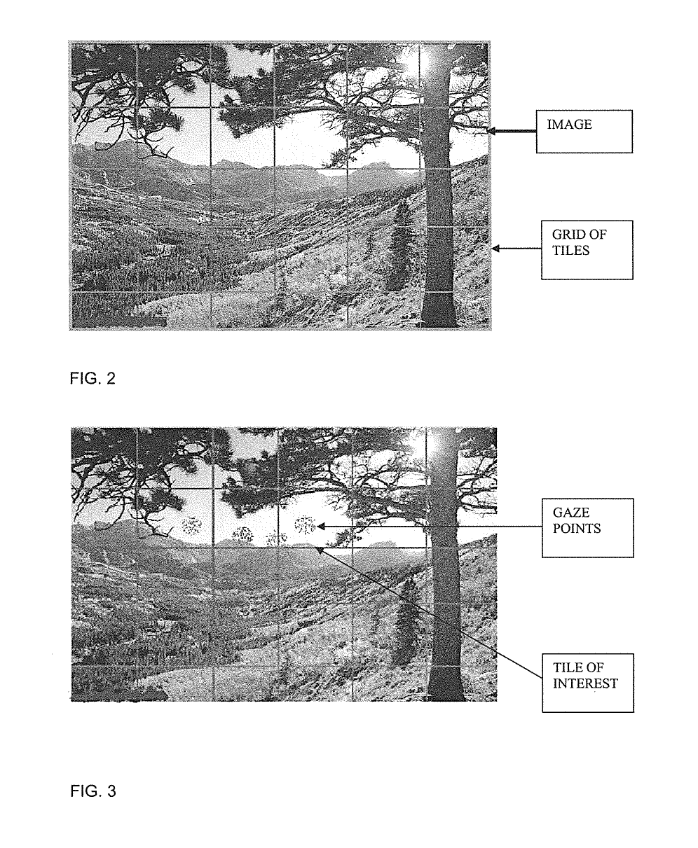

The displayed image is divided into a grid of tiles. In an example, the division is made prior to the display of the image. In another example, the image may be covered with a grid when it is being displayed to the user. The grid of tiles may underlie or overlie an image. Also, the grid of tiles or tiles per se is not visible to a user, since any visibility would mar a user's view of an image. An illustrative image with an underlying grid of tiles, according to an example, is provided in FIG. 2.

In block 120, while a user is viewing a displayed image, his or her gaze is detected to identify regions of the image that are of interest to the user.

Quite often a user is interested in some areas of the image more than the others. For example, let's assume a user is viewing an image displaying a number of mobile devices. If a user is interested in a particular handset then it is natural his or her gaze would tend to focus more on the region of the image displaying that handset. This region would qualify as a region of the image which is of interest to the user. To provide another example, let's consider an image containing different kinds of flowers, including roses. If a user is interested in roses, then it is natural that the user's gaze might focus on the region of the image that has captured roses. In such case, the rose containing region would qualify as a region of the image which is of interest to the user.

The gaze tracker is used to detect and track gaze of a user. It is a system which calculates a user's point of gaze on a display screen. The gaze tracker may be integrated with the computing device or communicatively coupled to the computing device through wired or wireless means. In an example, the gaze tracker tracks the gaze of a user based on relative position of two eye features: the pupil and corneal reflection of the eye. The data related to detection and movement of a user's gaze is transmitted from the gaze tracker to a processor of the computing device. The gaze tracker could be monocular (tracking one eye) or binocular (tracking both eyes).

In an example, the gaze tracker is used to detect and track a user's gaze to identify regions of interest on the displayed image, which are of interest to the user. Many known algorithms are available that could be used to detect areas of interest on an image based on user's gaze. In an example, Canny Edge Detection algorithm with Non-Maxima Suppression is used to identify a user's regions of interest. The algorithm highlights the regions of interests, while neglecting the non-interesting parts at the same time. Other suitable edge detection algorithms, such as, but not limited to, Kirsh, Prewitt and Sobel edge detection algorithms may be used to find regions of interest as perceived by a human user.

In an example, a graphical object (such as, but not limited to, circles, lines, dots, text, etc) may be used to indicate a user's gaze pattern and correspondingly regions of interest in an image. An illustrative image with a user's gaze pattern (dots) superimposed on the image, is provided in FIG. 3, according to an example.

Once a user's regions of interest on an image have been identified, the identified regions are mapped to the grid of tiles on the image, to recognize tiles of interest to the user (block 130).

As mentioned earlier (block 110), the image which is displayed on the computing device is divided into a grid of tiles, which are invisible to a user who is viewing the image. In an example, the Canny Edge Detection algorithm with Non-Maxima Suppression is used to map a user's regions of interest in an image to the grid of tiles. However, other suitable edge detection algorithms may also be used. The mapping is done to recognize tiles in the grid which are of interest to the user. In other words, the user's regions of interest are mapped to the grid to find tiles which are of interest to the user. In case of Canny Edge Detection algorithm with Non-Maxima Suppression, the algorithm is executed on the image to extract the relevant edges in the image, and every tile that contains an edge or a part of an edge is considered a tile of interest.

In an example, a tile is considered covered (and of interest to a user) if it contains more than a pre-defined number of gaze points. For example, a tile may be considered to be of interest to a user, if it contains, let's say, by way of example only, more than 5 gaze points. A tile that contains less than the pre-defined number of gaze points is not considered to be of interest to a user. In an example, the pre-determined number of gaze points is defined by the user.

After tiles of interest to a user have been identified, total number of tiles of interest for the image (block 140) is calculated. Subsequently, the number of tiles of interest for the image is compared against a threshold value which had been previously identified or computed for the user (block 150). A threshold value for a user is obtained by finding an average number of tiles which are of interest to a user given a set of images. The mechanism for obtaining a threshold value for a user is explained later.

A threshold value is specific to a user and may across different users. For example, a User A may have a threshold vale of 5 and a User B may have a threshold vale of 7. The numerals 5 and 7 represent the average number of tiles which were of interest to User A and User B, respectively, given a set of images.

The threshold value for a user may be stored in a database (storage medium) present in a memory of the computing device, or it may be stored in a database present in a memory of another device which may be communicatively coupled to the first computing device. Further, the aforementioned database may store threshold values for a multiple number of users.

In an example, once number of tiles of interest for the image is calculated, the number is compared against the threshold value for the user, which is obtained from the database stored on the computing device. If upon comparison it is found that the number of tiles of interest exceeds the threshold value (previously computed for the user), the user is presented with another image for viewing on the computing device. The “another” or subsequent image may be from a set of images identified by the user earlier or randomly selected by the computing device.

If upon comparison it is found that the number of tiles of interest does not exceed the threshold value for the user, the mechanism may continue to display the present image until the number of tiles of interest exceeds the threshold value for the user. In another example, however, the method may await a pre-defined time before displaying another image to the user.

As mentioned earlier, a threshold value for a user is obtained by finding an average number of tiles which are of interest to a user given a set of images. In an example, a threshold value for a user may be obtained in the following manner. The process may be termed as the “Training phase”.

In the training phase, a user is requested to view a set of images on a computing device, wherein, invisible to the user, each image is divided into a grid of tiles. Also, instead of advancing images automatically, the user is asked to advance the images manually. This could be done by providing an input through a key on a keyboard, clicking on a mouse, using a voice command like “Next” or through visual hand gestures. For each image, while the user is viewing the image, gaze of the user is detected by using a gaze tracker to identify regions of the image that are of interest to the user. In other words, gaze coordinates for parts of the image viewed by the user are captured. The user's gaze coordinates are then mapped to the grid of tiles on the image. Since a user's gaze coordinates would typically correspond with regions of photograph that might have interested the user, mapping the user's gaze coordinates to the grid of tiles on the image identifies tiles of interest for the user.

A user's gaze pattern or gaze coordinates are superimposed on the image. A graphical object (such as, but not limited to, circles, dots, symbol, text, etc.) is used to indicate a user's gaze pattern and correspondingly regions of interest in an image. The superimposed image is shown to the user at the end of the training phase to confirm that the data captured by the gaze tracker is valid, and to discard any invalid datasets.

As mentioned earlier, the Canny Edge Detection algorithm with Non-Maxima Suppression may be used to map a user's regions of interest in an image to the grid of tiles. However, other suitable edge detection algorithms may also be used. The mapping identifies tiles in the grid which are of interest to the user. A tile is considered covered (and of interest to a user) if it contains more than a pre-defined number of gaze points (coordinates).

The number of tiles of interest for the image is identified and stored.

The above process is repeated for each image (in the set of images) and the number of tiles of interest for each image is identified and stored. Subsequently, the total number of tiles of interest for all images (in the set) is added and an average number of tiles of interest is obtained for the given set of images. The average number of tiles of interest is identified as the “threshold value” for “the user”.

A threshold value is specific to a user and each user might have a different threshold value. The above mechanism can be used to identify a threshold value for a user given a set of images.

The threshold value for a user may be stored in a database present in a memory of the computing device, or it may be stored in a database present in a memory of another device which may be communicatively coupled to the first computing device. Further, the aforementioned database may store threshold values for a multiple number of users.

FIG. 2 shows an illustrative image with a grid of tiles, according to an embodiment. The grid of tiles shown in the representative image is for the purpose of description of the disclosure only. As mentioned earlier, the grid of tiles or tiles per se is not visible to a user who would be viewing the image. The grid may be created by an application or module residing in the memory of a user's computing device or in a device communicatively coupled to the user's computing device.

FIG. 3 shows an illustrative image with a user's gaze pattern superimposed on the image, according to an embodiment. In the representative image, a user's gaze pattern is superimposed on the image in the form of red dots. However, any another graphical object (such as, lines, text, an icon, etc.) may be used as well. The red dots represent a user's gaze pattern (points) and correspondingly regions of interest in an image. Once a user's regions of interest on an image have been identified (from user's gaze pattern), the identified regions are mapped to the grid of tiles on the image, to identify tiles of interest to the user.

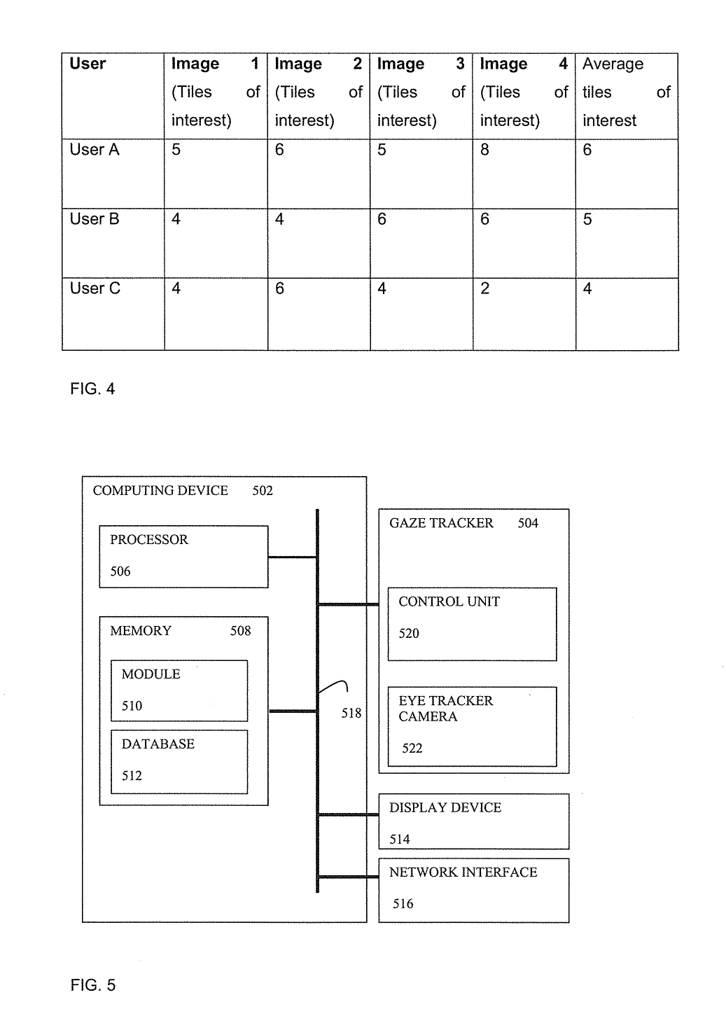

FIG. 4 shows an illustrative table providing threshold values, computed over a set of images, for multiple users, according to an embodiment. The table captures tiles of interest for three users, User A, User B and User C, across four images (Image 1, 2, 3, and 4). It also provides the average tile of interest value for the three users. The average tile of interest value is the threshold value, which is stored in a computing device and is later used to decide the display period between two images to the user.

FIG. 5 shows a block diagram of a system 500 for enabling an image slideshow using gaze of a user, according to an embodiment.

The system 500 includes a computing device 502 and a gaze tracker 504. The gaze tracker 504 may be a separate device, which may be removably attachable to the computing device 502, or it may be integrated with the computing device 502. The computing device 202 may communicate with the gaze tracker 504 by wired or wireless means.

The computing device 502, may be, but not limited to, a personal computer, a desktop computer, a laptop computer, a notebook computer, a network computer, a personal digital assistant (PDA), a mobile device, a hand-held device, or the like.

The computing device may include a processor 506, for executing machine readable instructions, a memory (storage medium) 508, for storing machine readable instructions (such as, a module 510) and a database 512, a display device 514 and a network interface 516. These components may be coupled together through a system bus 518. In an example, the display device, the gaze tracker and the processor are present together in a single computing device (unit).

Processor 506 is arranged to execute machine readable instructions. The machine readable instructions may be in the form of a module 510 or an application for executing a number of processes. In an example, the module displays an image to a user for viewing, wherein, invisible to the user, each image is divided into a grid of tiles. It also obtains a user's gaze data from the gaze tracker 504 and identifies regions of the image that are of interest to the user. Upon identification, the module maps the identified regions of interest to the grid of tiles on the image, to recognize tiles of interest to the user. Subsequently, it calculates the number of tiles of interest for the image and presenting another image to the user for viewing when the number of tiles of interest exceeds a threshold value previously computed for the user.

It is clarified that the term “module”, as used herein, means, but is not limited to, a software or hardware component. A module may include, by way of example, components, such as software components, processes, functions, attributes, procedures, drivers, firmware, data, databases, and data structures. The module may reside on a volatile or non-volatile storage medium and configured to interact with a processor of a computer system.

The memory 508 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. The memory 508 may include a module 510 and a database 512. The database may be used to store threshold value(s) of a user(s). It may also include details related to tiles of interest in an image(s) for a user(s).

The display device 514 may include a Virtual Display Unit (VDU) for displaying an image or a plurality of images present on the computing device 502.

Network interface 516 may act as a communication interface between computing device 502, and display device 514 and gaze tracker 504.

In an example, the gaze tracker 504 includes a control unit 520 and an eye tracker camera 522. The gaze tracker 504 calculates a user's point of gaze on the display device 514. Tracking of a user's gaze is based on relative position of two points on eye: pupil and corneal reflection. The eye tracker camera detects the gaze coordinates of the user when a user is viewing an image. It then transmits these gaze coordinates to the processor 506 of the computing device 502 either directly or through control unit 520, via network interface 516. In an example, the ASL Eye-Trac 5000 eye tracker (infrared version) was used. The tracker was configured to run at 60 Hz, generating on an average 60 gaze data points in a stream during one second.

It would be appreciated that the system components depicted in FIG. 5 are for the purpose of illustration only and the actual components may vary depending on the computing system and architecture deployed for implementation of the present solution. The various components described above may be hosted on a single computing system or multiple computer systems, including servers, connected together through suitable means.

The proposed solutions(s) enables prediction of an appropriate transition time suited for each individual based on user training data and real-time gaze tracking, so that a user could obtain a personalized slideshow experience.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present solution.

1. A computer implemented method of enabling an image slideshow based on gaze of a user, comprising:
displaying an image to a user for viewing, wherein, invisible to the user, the image is divided into a grid of tiles;
detecting, while the user is viewing the image, gaze of the user to identify regions of the image that are of interest to the user;
mapping the identified regions of interest to the grid of tiles on the image, to recognize tiles of interest to the user;
calculating number of tiles of interest for the image; and
presenting another image to the user for viewing when the number of tiles of interest exceeds a threshold value previously computed for the user.

2. A method of claim 1, wherein the image is from a set of images pre-selected by the user for viewing.

3. A method of claim 1, wherein computing a threshold value for a user comprises:
displaying an image, amongst a set of images, to a user for viewing, wherein, invisible to the user, each image is divided into a grid of tiles;
detecting, while the user is viewing the image, gaze of the user to identify regions of the image that are of interest to the user;
mapping the identified regions of interest to the grid of tiles on the image, to identify tiles of interest to the user;
calculating number of tiles of interest for the image;
repeating above steps for all images in the set, to obtain number of tiles of interest for each image individually; and
computing a threshold value for the user by calculating the average number of tiles of interest to the user across images present in the set.

4. A method of claim 3, further comprising recognizing manual selection of an image, amongst the set of images, by the user.

5. A method of claim 1, wherein a tile is considered to be of interest to the user, if it contains more than a pre-determined number of gaze points.

6. A method of claim 1, wherein mapping the identified regions of interest to the grid of tiles on the image, to recognize tiles of interest to the user, includes superimposing user's gaze points on the image.

7. A method of claim 6, wherein superimposition of user's gaze points on the image is represented by a graphical object.

8. A system for enabling an image slideshow based on gaze of a user, comprising:
a display device to display an image to a user for viewing, wherein, invisible to the user, the image is divided into a grid of tiles;
a gaze tracker to detect, while the user is viewing the image, gaze of the user, to identify regions of the image that are of interest to the user;
a processor that instructs an application:
to divide the image into a grid of tiles, which are invisible to the user;
to map the identified regions of interest to the grid of tiles on the image, to recognize tiles of interest to the user;
to calculate number of tiles of interest for the image; and
to present another image to the user for viewing on the display device when the number of tiles of interest exceeds a threshold value previously computed for the user.

9. The system of claim 8, wherein a tile is considered to be of interest to the user, if it contains more than a pre-determined number of gaze points.

10. The system of claim 9, wherein the pre-determined number of gaze points is defined by the user.

11. The system of claim 8, wherein the image is from a set of images pre-selected by the user for viewing.

12. The system of claim 8, further comprising a memory to store the threshold value previously computed for the user.

13. The system of claim 8, wherein the gaze tracker includes an eye tracker camera for tracking a user's gaze to identify regions of the image that are of interest to the user

14. The system of claim 8, wherein the display device, the gaze tracker and the processor are present together in a single unit.

15. A computer program comprising computer readable means adapted to execute the method of claim 1 when said program is run on a computer system.
